(19) United States
(12) Patent Application Publication
(10) Pub. No.: US 2018/0236714 A1
(43) Pub. Date: Aug. 23, 2018

(54) ADDITIVE MANUFACTURING PRODUCTS AND PROCESSES

(71) Applicant: SABIC Global Technologies B.V., Bergen op Zoom (NL)

(72) Inventors: Abdul Salam THELAKKADAN, Riyadh (SA); Tariq SYED, Riyadh (SA); Syed Mahmood AHMED, Hockessin, DE (US); Abdullah Shamroukh OTAIBI-AL, Riyadh (SA)

(21) Appl. No.: 15/752,984

(22) PCT Filed: Aug. 25, 2016
(86) PCT No.: PCT/US2016/048607

§ 371 Date: Feb. 15, 2018

Related U.S. Application Data
(60) Provisional application No. 62/211,339, filed on Aug. 28, 2015.

(51) Int. Cl. B29C 64/371; B29C 64/135; B29C 64/153; B22F 3/105; B29C 64/295; B29C 71/04

(52) U.S. Cl. CPC B29C 64/371; B29C 64/135; B29C 64/153; B33Y 10/00; B29C 64/295; B29C 71/04; B22F 2201/20; B22F 3/1055

(57) ABSTRACT

The disclosure describes systems and methods for performing additive manufacturing. The method includes forming a first layer of a product on a target surface, heating a portion of the first layer with a directed energy source, and forming a second layer of the product on the first layer. The system for performing additive manufacturing includes a vacuum chamber, a target surface disposed in the vacuum chamber, a first layer of material formed on the target surface, a directed energy source configured to heat a portion of the first layer, and a second layer of material formed on the heated portion of the first layer.

### CROSS REFERENCE TO RELATED APPLICATIONS

This application claims the benefit of and priority to U.S. Patent Application No. 62/211,339, filed Aug. 28, 2015, which is hereby incorporated herein by reference in its entirety.

### FIELD OF DISCLOSURE

This present disclosure relates generally to additive manufacturing, and more particularly to modifying a previously formed layer in 3D printing.

### BACKGROUND OF THE DISCLOSURE

3D printing (also known as additive manufacturing, or “AM”) refers to any process that may be used to make a three-dimensional product. Additive processes are used in 3D printing where successive layers of material are applied to form a product or part. These parts can be almost any shape or geometry, and are produced from a 3D model on a computer or other electronic device.

3D printing originally referred to processes that sequentially deposited material onto a powder bed with inkjet printer heads. However, more recently the meaning of the term 3D printing has expanded to encompass a wider variety of techniques such as extrusion and sintering based processes. The term additive manufacturing is often used to refer to this broader application.

A variety of additive manufacturing processes are currently available. The main differences between processes are in the way layers are deposited to create parts and in the materials that are used. Some methods melt or soften material to produce the layers, while others cure liquid materials using different technologies, or cut thin layers to shape and join them together. Selective laser melting (SLM), direct metal laser sintering (DMLS), selective laser sintering (SLS), fused deposition modeling (FDM), and fused filament fabrication (FFF) are types of additive manufacturing methods that melt or soften material to produce the layers.

Selective laser sintering, for example, is an additive manufacturing technique that may use a laser as the power source to sinter powdered material, such as a polymer or metal. The system aims the laser at points in space as defined by a 3D model, binding the material together to create a solid structure. SLS, as well as the other AM techniques mentioned, have mainly been used for rapid prototyping and for low-volume production of component parts.

Existing systems suffer from certain drawbacks in that they may not adequately modify the previously formed layer before the addition of subsequent layers, resulting in increased porosity or decreased adhesive capability. These and other shortcomings of the prior references are addressed by the present disclosure.

### SUMMARY

Systems and methods for additive manufacturing are disclosed and claimed herein.

As described more fully below, the apparatus and processes of the embodiments disclosed permit improved systems and methods for 3D additive layer printing. Further aspects, products, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

In one aspect, the disclosure describes a method of manufacturing a product, the method comprising forming a first layer of a product on a target surface, heating a portion of the first layer with a directed energy source, and forming a second layer of the product on the first layer.

In some embodiments, the step of forming the first layer of the product comprises depositing a first layer of powder on a target surface, and directing an energy beam at the first layer to create a fused first layer. The step of forming the second layer of the product may further comprise depositing a second layer of powder onto the fused first layer, and directing the energy beam at the second layer to create a fused second layer wherein the fused second layer is fused to the heated portion of the fused first layer.

In other embodiments, the step of forming the first layer of the product comprises depositing a molten layer of material on the target surface and solidifying the molten layer. The step of forming the second layer of the product may further comprise depositing a molten layer of material on the target surface wherein the second layer is deposited on the heated portion of the first layer.

In certain embodiments, the portion of the first layer is heated to at least a glass transition temperature of the first layer. In other embodiments, the portion of the first layer is heated to a temperature between a glass transition temperature of the first layer and a melting temperature of the first layer.

In certain embodiments, the portion of the fused first layer may be heated to at least a glass transition temperature of the fused first layer. In particular, the portion of the fused first layer may be heated to a temperature between a glass transition temperature of the fused first layer and a melting temperature of the fused first layer.

In another aspect, the disclosure describes a product produced by a process comprising the steps of forming a first layer of the product on a target surface, heating a portion of the first layer with a directed energy source, and forming a second layer of the product on the first layer.

In another aspect, the disclosure describes a system for performing additive manufacturing, the system comprising a vacuum chamber, a target surface disposed in the vacuum chamber, a first layer of material formed on the target surface, a directed energy source configured to heat a portion of the first layer, and a second layer of material formed on the heated portion of the first layer.

Further and alternative aspects and features of the disclosed principles will be appreciated from the following detailed description and the accompanying drawings. As will be appreciated, the systems and methods disclosed herein are capable of being carried out in other and different aspects, and capable of being modified in various respects. Accordingly, it is to be understood that both the foregoing general description and the following detailed description are exemplary and explanatory only and do not restrict the scope of the appended claims.

### BRIEF DESCRIPTION OF THE FIGURES

FIG. 1 is a schematic diagram of an aspect of an additive manufacturing system.

FIG. 2 is a schematic diagram of an aspect of an additive manufacturing system including a powder delivery system.

FIG. 3 is a schematic diagram of an aspect of an additive manufacturing system including more than one energy beam.

FIG. 4 is a schematic diagram of another aspect of an additive manufacturing system including more than one energy beam.

FIG. 5 is a schematic diagram of another aspect of an additive manufacturing system.

FIG. 6 is a flow chart illustrating steps of a method of additive manufacturing according to principles of the present disclosure.

### DETAILED DESCRIPTION

The present disclosure can be understood more readily by reference to the following detailed description of the disclosure and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “effective amount” refers to an amount that is sufficient to achieve the desired modification of a physical property of the composition or material.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

The disclosure relates to producing products in additive manufacturing systems with increased mechanical strength, increased density, and reduced porosity. The approach may involve using a vacuum chamber, and an energy source such as a laser or ultrasound to increase the localized surface temperature of the previously added layer of material to just below the melting temperature of the previously added layer, where addition of a new additive layer is going to be applied. To decrease the cost and foot print of the equipment, the energy beam can be split into two energy beams. In a split beam configuration, one of the split beams may be used to increase the local surface temperature of the previously added layer where the next layer of material is to be applied. In particular, this disclosure relates to manufacturing methods and systems that can be used to fabricate crystalline polycarbonate products while maintaining the degree of crystallinity of the crystalline polycarbonate and provide other associated performance advantages.

In certain embodiments, various methods may be used to manufacture products or parts with different material structures and properties. For example, when using a crystalline polymer, such as crystalline polycarbonate, either an amorphous polycarbonate part or a crystalline polycarbonate part can be produced. Different material structures and properties may be desired such that one type of product may be preferred over another, depending on the application.

Polycarbonate is an amorphous, highly transparent and very high impact strength polymer with a wide range of applications. However, polycarbonate may be crystallized to provide different material properties, if desired. For example, while amorphous polycarbonate has poor solvent resistance and loses its mechanical strength above its glass transition temperature (T_{g}) (around 150° C.), thus limiting its application range, crystalline polycarbonate may overcome these deficiencies. Crystalline polycarbonate may have several desirable physical performance characteristics as compared to amorphous polycarbonate, such as a Vicat softening temperature above 180° C., better dimensional stability above T_{g}, increased solvent resistance, increased solvent stress crack resistance, increased water repellant characteristics, and increased detachability from a mold at temperatures above the T_{g} without sticking. Amorphous polycarbonate may provide advantages over crystalline polycarbonate in certain instances, including a higher density, decreased porosity, and increased mechanical strength.

The most common methods of fabricating finished polycarbonate products are extrusion and injection molding. However, since polycarbonate generally is a slow crystallizing polymer, once the polycarbonate is melted, the crystallinity typically may not be present in the product again. Thus, the crystallinity cannot be sustained when the crystalline polycarbonate is subjected to the processing conditions in conventional extrusion and injection molding machines.

Polymer or metal powders are used in many forms of additive manufacturing. Crystalline polymer powders are generally more suited for some 3D printing processes, as they exhibit a sharp melting point, whereas amorphous polymers exhibit more of a gradual melting range that may make them less desirable in some 3D printing processes, as some of the amorphous polymer surrounding a target area may be melted unintentionally.

Now referring to the drawings, wherein like reference numbers refer to like elements, there are illustrated systems for performing additive manufacturing. The systems may be any additive manufacturing system where material is added to produce layers, such as systems using selective laser sintering (SLS), fused deposition modeling (FDM), selective laser melting (SLM), direct metal laser sintering (DMLS), and fused filament fabrication (FFF) to name a few.

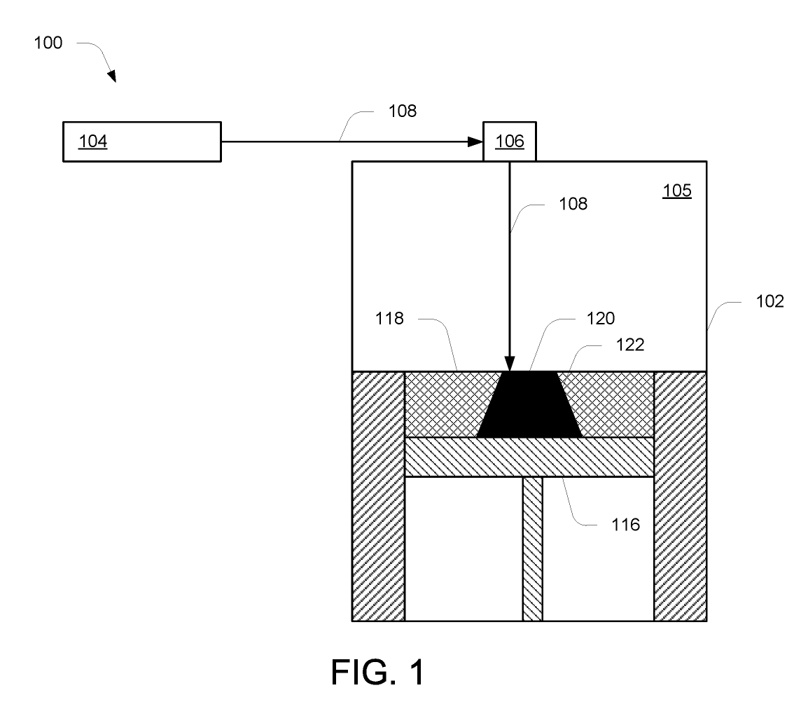

Referring to FIG. 1, a system 100 for performing additive manufacturing will now be described. In FIG. 1, the system 100 may include a chamber 102 with a fabrication area 105 located inside the chamber 102. In other embodiments, the system 100 may not be enclosed in a chamber. The system 100 may further include an energy source 104, such as a laser or ultrasound emitter. In the embodiment shown in FIG. 1, the energy source 104 is located outside of the chamber 102, though in other embodiments the energy source 104 may be located inside the chamber 102. The fabrication area 105 may further include a fabrication piston 116, a fabrication powder bed 118 disposed above the fabrication piston 116, and a target area 120 of initial powder on the top surface of the fabrication powder bed 118. As the product 122 is created, the fabrication piston 116 may lower the product 122 such that the target area 120 remains on substantially the same plane as the top of the fabrication powder bed 118, such that once a fused layer of an product is created from an initial layer of powder, additional powder may be evenly applied to the previously fused layer of the product that was created. The fabrication powder bed 118 may be heated to keep the temperature of the powder elevated before processing, thus requiring less energy to sinter or melt the powder. In embodiments, a heated air system may be used to heat the powder.

During the fabrication process, the energy source 104 may emit an energy beam 108 that is directed to the target area 120. In certain embodiments, a scanner system 106 may direct the energy beam 108, where the scanner system 106 may include one or more mirrors or prisms to direct the energy beam 108 in the desired direction.

The energy beam 108 may be of sufficient power to heat a layer of the powder on the target area 120 to create a fused layer. In the system 100, the energy source 104 may be directed to heat the previously created fused layer before a subsequent fused layer is created. A second layer of powder may then be deposited on the previously fused layer, and the energy source 104 may then fuse the subsequent layer with the fused first layer, where the fused second layer may be fused to the heated portion of the fused first layer. In some embodiments, the fused second layer may then be heated in a similar manner as the previously fused layer, before additional layers are created. Additional powder may be deposited over previously fused layers as needed to create additional layers of the product 122. This process may be repeated any number of times to complete the fabrication of product 122. A portion may either be the entire layer or a subset of the layer smaller than the entire layer.

The powder may be heated just enough to sinter the powder together, where the sintering temperature is less than the melting temperature, or the powder may be heated above a melting temperature of the powder to melt the powder. Once a fused layer is created, the energy beam 108 may then be directed to heat a portion of the fused first layer to a temperature above a glass transition temperature but less than a melting temperature of the fused first layer. This may result in decreasing the viscosity of the fused first layer. Decreasing the viscosity of the previously fused layer may result in an increased density and decreased porosity in the product being created, by allowing gas bubbles that may be present inside the previously fused layer to escape. A decreased vacuum pressure may further aid in increasing the density and decreasing the porosity of the product being created. The energy directed at the previously fused layer may also soften the previously fused layer and allow for better adhesion to the next layer of material to be added.

The powder may be any material suitable for additive manufacturing, such as a polymer or metal. Nylon, in particular nylon 12, is often used in current additive manufacturing applications. Other polymers such as polycarbonate may also be used, in particular crystalline polycarbonate. In a preferred embodiment, crystalline polycarbonate powder may be used, where the crystalline polycarbonate has about a 26% degree of crystallinity. Polycarbonates may be produced with other percentages of crystallinity depending on the process used to create the polycarbonate. For example, crystalline polycarbonate formed using an acetone treatment may have up to about 30% crystallinity, whereas polycarbonate formed with a nucleating agent may have up to about 60% crystallinity.

The melting temperature (Tm) of crystallized polycarbonate can be up to about 300° C., and the crystallized polycarbonate can have a crystallinity (X_{c}) up to about 60% depending on the method of crystallization. A simple acetone treatment may result in a Tm of about 220° C. and an X_{c} of up to about 30%. The use of some organic nucleating agents may result in a Tm of about 300° C. and an X_{c} of about 60%. Solid state polymerization can also be used for making crystallized polycarbonate with a Tm of about 260° C.

In an example embodiment where a crystalline polycarbonate part is produced, a crystalline polycarbonate powder may be heated to at least a temperature above the T_{g} of about 145° C. to fuse the powder together into a layer, such as to about 185° C.-215° C. for example. The previously formed layer may then be heated to a temperature between a T_{g} and Tₘ of the layer, for example to about 215° C., but not over the Tm of the crystalline polycarbonate (about 220° C.), as the subsequent layer is added. The subsequent layer of material is then added to the heated previously fused layer. Since the crystalline polycarbonate powder is not heated above its melting temperature in this embodiment, the resulting part may maintain the crystallinity of the polycarbonate, and thus its associated properties.

In an embodiment where an amorphous polycarbonate part is produced, the crystalline polycarbonate powder may be heated to at least a temperature above the Tₘ of about 220° C. to fuse the powder together into a layer. This layer may then be allowed to cool below the melting temperature to solidify. The previously formed layer may then be heated to a temperature between a T_{g} and Tₘ of the layer, for example to about 215° C., but not over the Tₘ of the crystalline polycarbonate (about 220° C.), as the subsequent layer is added. The subsequent layer of material is then added to the heated previously fused layer. Since the polycarbonate in this embodiment is heated to above its melting temperature, the crystalline polycarbonate will lose its crystal structure and become amorphous polycarbonate. However, because the polycarbonate is heated to a higher temperature in this embodiment, the resulting part may have increased density, decreased porosity, and increased mechanical strength as compared to a part made of crystalline polycarbonate.

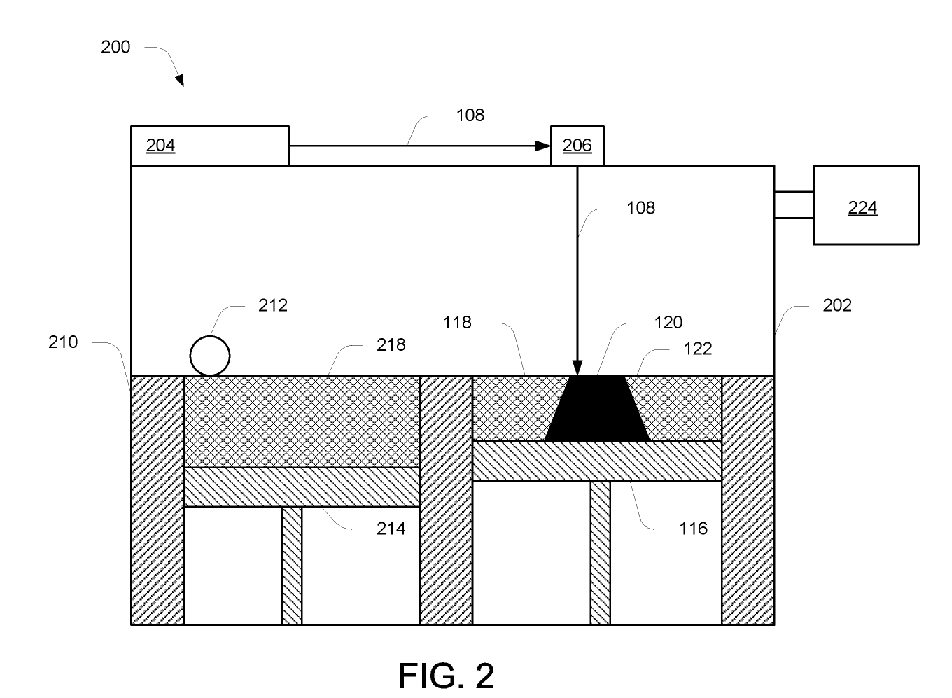

Referring now to FIG. 2, a system for performing additive manufacturing will now be described in further detail. In an embodiment, the chamber 202 may be a vacuum chamber, where the chamber 202 may be substantially sealed and in fluid communication with a vacuum system 224. The vacuum system 224 may be used to decrease the pressure in the chamber 202, such that any gas bubbles trapped in the previously fused layer may encounter less resistance when escaping. The pressure may be any pressure suitable to decrease the porosity of the material, such as about 5-25 mmHg.

In addition to the features described above with respect to FIG. 1, the chamber 202 may further include a powder delivery system 210. The powder delivery system 210 may include a roller 212, a powder delivery piston 214, and a powder storage bed 218. At an initial position, the roller 212 is disposed over the powder storage bed 218, where additional powder is stored. If an additional layer of powder is to be applied to the target area 120, the roller 212 rolls across the surface of the powder storage bed 218 in the direction of the target area 120, pushing an amount of powder along and depositing it on the target area 120. The powder delivery piston 214 rises to push the powder storage bed 218 up and keep the surface of the storage bed 218 coplanar with the top surface of the fabrication powder bed 118. In certain embodiments, the powder may be compacted by a roller 212 or other device capable of supplying sufficient pressure to compact the layer of powder on the target area 120 before the layer of powder is fused together.

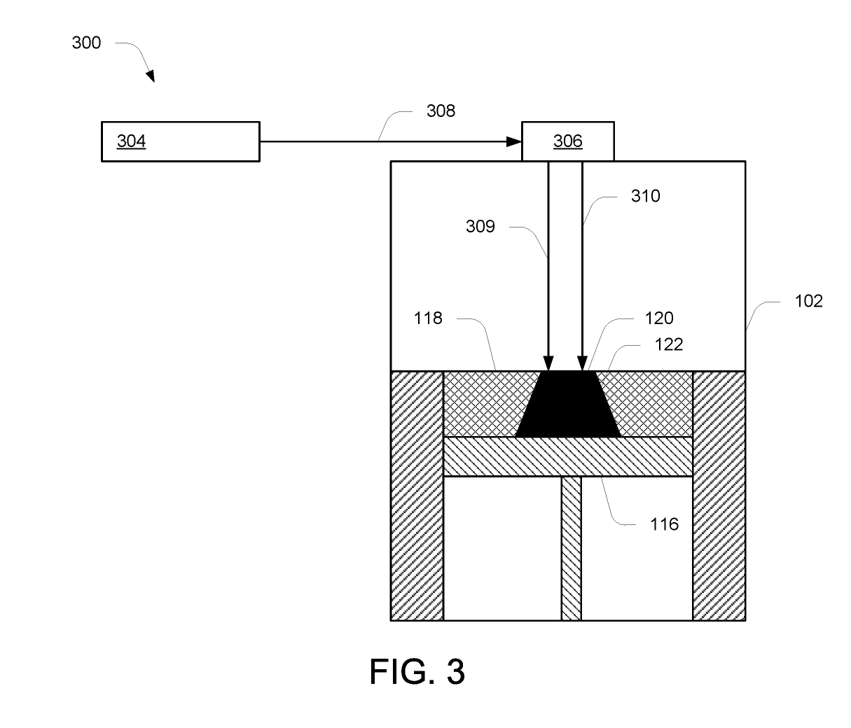

Referring now to FIG. 3, another embodiment of a system for performing additive manufacturing will now be described. In FIG. 3, the energy beam 308 from energy source 304 may be split into a first energy beam 309 and a second energy beam 310. In certain embodiments, the energy beam 308 may be split inside the scanner system 306. In other embodiments, the energy beam 308 may be split before the scanner system 306 and then directed using the scanner system 306. The energy beam 308 may be split using a beam splitter or any other device used to split energy beams.

In embodiments with more than one energy beam, one beam may be used to fuse the powder into a fused layer, and a second energy beam may be used to heat the previously fused layer. For example, the first energy beam 309 may be at a higher power than the second energy beam 310, and the first energy beam 309 may fuse the powder, while the second energy beam 310 heats the previously fused layer. In other embodiments, more than one scanner system 306 may be used for each portion of the energy beam, such that the first energy beam 309 and the second energy beam 310 may be directed by different scanner systems.

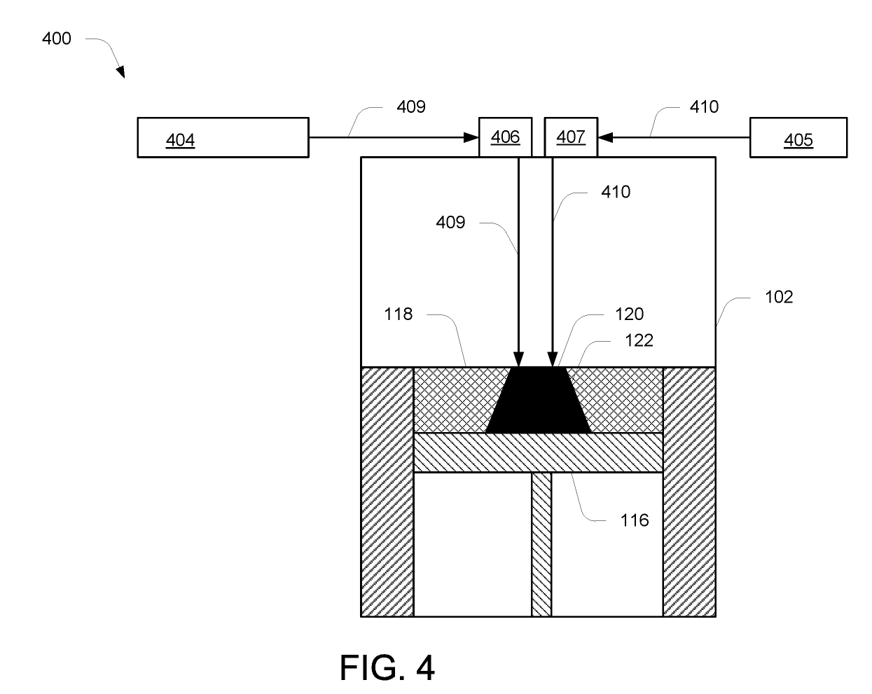

Referring now to FIG. 4, another embodiment of a system for performing additive manufacturing will now be described. In FIG. 4, the system may include a first energy beam 409 from a first energy source 404 and a second energy beam 410 from a second energy source 405. The first energy beam 409 may be at a higher power than the second energy beam 410, and the first energy beam 409 may fuse the powder, while the second energy beam 410 may heat the previously fused layer. One scanner system 406 may be used to direct the energy beams, however in other embodiments, more than one scanner system 406 may be used for each energy beam, such that the first energy beam 409 and the second energy beam 410 may be directed by different scanner systems. In the embodiment shown in FIG. 4, second scanner system 407 is used to direct the second energy beam 410.

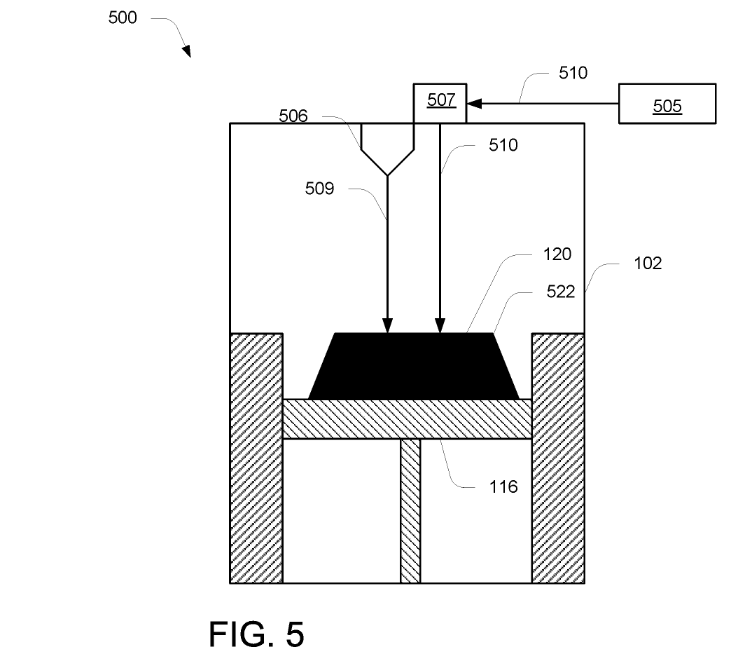

Referring now to FIG. 5 another aspect of an additive manufacturing system will be described. In FIG. 5, a molten deposition or an extrusion type of system is shown, such as a fused deposition modeling (FDM) or fused filament fabrication (FFF) system. In the types of systems shown in FIG. 5, a molten layer of material 509 from a dispenser 506 can be deposited onto a surface 120 to create a product 522. In some embodiments, the dispenser 506 may be an extruder, and a filament or bulk material may be fed into the extruder. The dispenser 506 can include a heat source such as a heating coil to heat the material as it is dispensed. Once a first layer is formed, a portion of the first layer may be heated by an energy source 505 before an additional layer is added. In certain embodiments, the additional layer is added to the portion of the first layer that has been heated by an energy beam 510 from an energy source 505 and directed by a scanner system 507. In some embodiments, the additional layer may then be heated in a similar manner as the previously formed first layer, before further layers are formed. Additional layers may be deposited over previously formed layers as needed to create additional layers of the product 522. This process may be repeated any number of times to complete the fabrication of product 522.

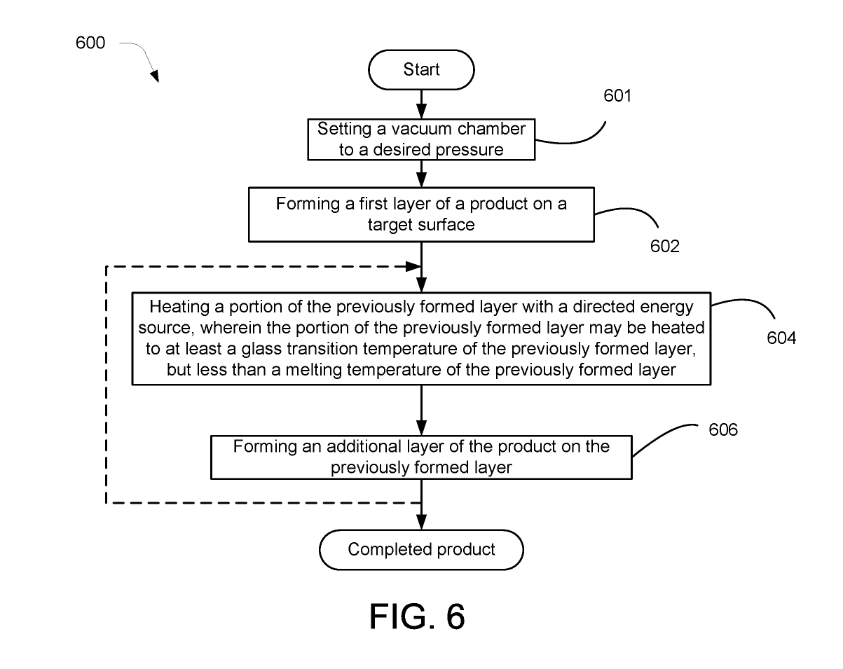

Referring now to FIG. 6, a flow chart illustrating steps of a method 600 of additive manufacturing according to principles of the present disclosure will now be described. In method 600, at step 601, a vacuum chamber may be set to a desired pressure. As an example, the vacuum chamber may be evacuated to a pressure of 25 mmHg. Step 602 includes forming a first layer of material on a target area. In certain embodiments, the target area may be the target area 120 located in the chamber 102. In step 604, a portion of the first layer is heated, where the portion heated is the region where the next layer will be formed upon. In some embodiments, the portion of the first layer may be heated to at least a glass transition temperature of the first layer, but less than a melting temperature of the first layer. A second layer of material is then formed on the first layer in step 606. In some embodiments, additional layers may be heated in a similar manner as the previously formed first layer, before further layers are formed. Additional layers may be formed over previously formed layers as needed to create additional layers of the product. The steps 604 and 606 may be repeated as needed to produce any number of layers to make a completed product.

In various aspects, the present invention pertains to and includes at least the following aspects.

Aspect 1: A method of manufacturing a product, the method comprising:
forming a first layer of a product on a target surface;
heating a portion of the first layer with a directed energy source; and
forming a second layer of the product on the first layer.

Aspect 2: The method of Aspect 1, wherein the step of forming the first layer of the product comprises depositing a first layer of powder on a target surface, and directing an energy beam at the first layer to create a fused first layer.

Aspect 3: The method of Aspects 1 or 2, wherein the step of forming the second layer of the product comprises depositing a second layer of powder onto the fused first layer, and directing the energy beam at the second layer to create a fused second layer wherein the fused second layer is fused to the heated portion of the fused first layer.

Aspect 4: The method of any of the previous Aspects, wherein the step of forming the first layer of the product comprises depositing a molten layer of material on the target surface and solidifying the molten layer.

Aspect 5: The method of Aspect 4, wherein the step of forming the second layer of the product comprises depositing a molten layer of material on the target surface wherein the second layer is deposited on the heated portion of the first layer.

Aspect 6: The method of any of the previous Aspects, wherein the portion of the first layer is heated to at least a glass transition temperature of the first layer.

Aspect 7: The method of Aspect 6, wherein the portion of the first layer is heated to a temperature between a glass transition temperature of the first layer and a melting temperature of the first layer.

Aspect 8: The method of any of Aspects 2 to 7, wherein the first layer of powder is heated to at least a melting temperature of the first layer of powder to create the first fused layer.

Aspect 9: The method of any of Aspects 2 to 8, wherein the first layer of powder is heated to a temperature between a glass transition temperature of the first layer of powder and a melting temperature of the first layer of powder to create the first fused layer.

Aspect 10: The method of any of the previous Aspects, wherein the directed energy source is a laser beam.

Aspect 11: The method of any of Aspects 2 to 10, wherein the energy beam is split into a first beam and a second beam, the first beam heating the first layer to fuse the first layer, and the second beam heating the portion of the fused first layer, wherein a power of the first beam is greater than a power of the second beam.

Aspect 12: The method of any of the previous Aspects, wherein the directed energy source is an ultrasound emitter.

Aspect 13: The method of any of the previous Aspects, wherein the first layer is heated in a vacuum chamber.

Aspect 14: The method of any of the previous Aspects, wherein the first layer is a polymer.

Aspect 15: The method of Aspect 14, wherein the polymer is a polycarbonate.

Aspect 16: The method of Aspect 15, wherein the polycarbonate is a crystalline polycarbonate.

Aspect 17: The method of Aspect 14, wherein the polymer is a nylon.

Aspect 18: A product produced by a process comprising the steps of:
forming a first layer of the product on a target surface;
heating a portion of the first layer with a directed energy source; and
forming a second layer of the product on the first layer.

Aspect 19: The product produced by the process of Aspect 18, wherein the step of forming the first layer of the product comprises depositing a first layer of powder on a target surface, and directing an energy beam at the first layer to create a fused first layer;
wherein the portion of the first layer is heated to at least a glass transition temperature of the first layer; and
wherein the step of forming the second layer of the product comprises depositing a second layer of powder onto the fused first layer, and directing the energy beam at the second layer to create a fused second layer wherein the fused second layer is fused to the heated portion of the fused first layer.

Aspect 20: The product produced by the process of Aspect 18, wherein the step of forming the first layer of the product comprises depositing a molten layer of material on the target surface and solidifying the molten layer;
wherein the portion of the first layer is heated to at least a glass transition temperature of the first layer; and
wherein the step of forming the second layer of the product comprises depositing a molten layer of material on the target surface wherein the second layer is deposited on the heated portion of the first layer.

Aspect 21: A system for performing additive manufacturing, comprising:
a vacuum chamber;
a target surface disposed in the vacuum chamber;
a first layer of material formed on the target surface;
a directed energy source configured to heat a portion of the first layer; and
a second layer of material formed on the heated portion of the first layer.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. A method of manufacturing a product, the method comprising:
forming a first layer of a product on a target surface;
heating a portion of the first layer with a directed energy source; and
forming a second layer of the product on the first layer.

2. The method of claim 1, wherein the step of forming the first layer of the product comprises depositing a first layer of powder on a target surface, and directing an energy beam at the first layer to create a fused first layer.

3. The method of claim 1, wherein the step of forming the second layer of the product comprises depositing a second layer of powder onto the fused first layer, and directing the energy beam at the second layer to create a fused second layer wherein the fused second layer is fused to the heated portion of the fused first layer.

4. The method of claim 1, wherein the step of forming the first layer of the product comprises depositing a molten layer of material on the target surface and solidifying the molten layer.

5. The method of claim 4, wherein the step of forming the second layer of the product comprises depositing a molten layer of material on the target surface wherein the second layer is deposited on the heated portion of the first layer.

6. The method of claim 1, wherein the portion of the first layer is heated to at least a glass transition temperature of the first layer.

7. The method of claim 6, wherein the portion of the first layer is heated to a temperature between a glass transition temperature of the first layer and a melting temperature of the first layer.

8. The method of claim 2, wherein the first layer of powder is heated to at least a melting temperature of the first layer of powder to create the first fused layer.

9. The method of claim 2, wherein the first layer of powder is heated to a temperature between a glass transition temperature of the first layer of powder and a melting temperature of the first layer of powder to create the first fused layer.

10. The method of claim 1, wherein the directed energy source is a laser beam.

11. The method of claim 2, wherein the energy beam is split into a first beam and a second beam, the first beam heating the first layer to fuse the first layer, and the second beam heating the portion of the fused first layer, wherein a power of the first beam is greater than a power of the second beam.

12. The method of claim 1, wherein the directed energy source is an ultrasound emitter.

13. The method of claim 1, wherein the first layer is heated in a vacuum chamber.

14. The method of claim 1, wherein the first layer is a polymer.

15. The method of claim 14, wherein the polymer is a polycarbonate.

16. The method of claim 15, wherein the polycarbonate is a crystalline polycarbonate.

17. The method of claim 14, wherein the polymer is a nylon.

18. A product produced by a process comprising the steps of:
forming a first layer of the product on a target surface;
heating a portion of the first layer with a directed energy source; and
forming a second layer of the product on the first layer.

19. The product produced by the process of claim 18, wherein the step of forming the first layer of the product comprises depositing a first layer of powder on a target surface, and directing an energy beam at the first layer to create a fused first layer;
wherein the portion of the first layer is heated to at least a glass transition temperature of the first layer; and
wherein the step of forming the second layer of the product comprises depositing a second layer of powder onto the fused first layer, and directing the energy beam at the second layer to create a fused second layer wherein the fused second layer is fused to the heated portion of the fused first layer.

20. The product produced by the process of claim 18, wherein the step of forming the first layer of the product comprises depositing a molten layer of material on the target surface and solidifying the molten layer;
wherein the portion of the first layer is heated to at least a glass transition temperature of the first layer; and
wherein the step of forming the second layer of the product comprises depositing a molten layer of material on the target surface wherein the second layer is deposited on the heated portion of the first layer.
